(19) United States
(12) Patent Application Publication
(10) Pub. No.: US 2013/0226655 A1
(43) Pub. Date: Aug. 29, 2013

(54) METHOD AND SYSTEM FOR STATISTICAL ANALYSIS OF CUSTOMER MOVEMENT AND INTEGRATION WITH OTHER DATA

(71) Applicant: BVI Networks, Inc., (US)

(72) Inventor: George Shaw, Palo Alto, CA (US)

(73) Assignee: BVI Networks, Inc., San Jose, CA (US)

(21) Appl. No.: 13/750,161

(22) Filed: Jan. 25, 2013

Related U.S. Application Data
(60) Provisional application No. 61/605,074, filed on Feb. 29, 2012.

(51) Int. Cl. G06Q 30/02

(52) U.S. Cl. CPC G06Q 30/0201
USPC 705/7.29

(57) ABSTRACT

Movement patterns for customers in a retail environment are quantified using a set of movement traces. The quantifications are correlated with other retail metrics to determine which patterns are conducive to positive results for the retailer. In an implementation, first and second distributions are generated using the movement traces. One of the first or second distributions is compared to another of the first or second distributions. A value is calculated indicating a degree of difference between the distributions. In another implementation, a set of node sequences representing paths of customers in the retail environment are obtained. The node sequences are associated with consumer behavior patterns. A target customer is tracked and a target node sequence representing a current path of the target customer is generated. The target node sequence is compared with the set of node sequences to make a prediction about the target customer.

### CROSS-REFERENCE TO RELATED APPLICATIONS

This patent application claims priority to U.S. provisional patent application 61/605,074, filed Feb. 29, 2012, and is incorporated by reference along with all other references cited in this application.

### BACKGROUND

The present invention relates to the field of information technology, including, more particularly, to systems and techniques for quantifying movement patterns.

Tracking subjects through a real world space offers benefits in a variety of areas including commercial, business, corporate, security, government, science, and others. For example, brick and mortar businesses have long desired to gather data that would allow them to better understand customer behavior. Such data can be used to make decisions about merchandising, advertising, pricing, staffing, design new in-store concepts, and, in particular, understand how customers interact with store displays, make correlations with sales data, calculate conversion rates, identify good locations for merchandise, identify poor performing products and locations, improve store layout, provide targeted promotions, and much more.

Providing traditional retailers with a data-driven approach can help them provide the best possible shopping experience, stay ahead of constantly evolving customer needs, reduce cost and significantly increase revenue per square foot.

### BRIEF SUMMARY OF THE INVENTION

Movement patterns for customers in a retail environment are quantified using a set of movement traces. The quantifications are correlated with other retail metrics to determine which patterns are conducive to positive results for the retailer. In an implementation, first and second distributions are generated using the movement traces. One of the first or second distributions is compared to another of the first or second distributions. A value is calculated indicating a degree of difference between the distributions. In another implementation, a set of node sequences representing paths of customers in the retail environment are obtained. The node sequences are associated with consumer behavior patterns. A target customer is tracked and a target node sequence representing a current path of the target customer is generated. The target node sequence is compared with the set of node sequences to make a prediction about the target customer.

In a specific implementation, a method includes collecting first tracking data representing movements of a first set of customers through a store during a first time period, generating a first distribution using the first tracking data, collecting second tracking data representing movements of a second set of customers through the store during a second time period, different from the first time period, generating a second distribution using the second tracking data, comparing one of the first or second distributions to another of the first or second distributions, and based on the comparison, calculating a first value indicating a degree of difference between the one of the first or second distributions and the other of the first or second distributions.

Generating a first distribution may include establishing a set of locations on a floor plan of the store, and analyzing the first tracking data against the set of locations to count a number of customers of the first set of customers passing by each location of the set of locations during the first time period. Generating a second distribution may include analyzing the second tracking data against the set of locations to count a number of customers of the second set of customers passing by each location of the set of locations during the second time period. The first time period may include a first day of a week, and the second time period may include a second day of the week, different from the first day.

In a specific implementation, the first tracking data includes a set of tracks, each track being associated with a customer of the first set of customers and being defined by a set of points, each point indicating a position of the customer in the store at a time during the first time period. In this specific implementation, the generating a first distribution includes dividing a floor plan of the store into a set of locations, each location being associated with a counter variable, determining whether a first point of a first track associated with a first customer is within a first location of the plurality of locations, and if the first point is within the first location, thereby indicating that the first customer visited the first location, incrementing a first counter variable associated with the first location.

The first distribution may include a first spatial histogram and the second distribution may include a second spatial histogram. The first value may include a Kullback-Leibler (KL) divergence. The method may further include calculating for at least one of the first or second distributions a second value indicating an amount of randomness in the at least one of the first or second distributions. The method may further include calculating for at least one of the first or second distributions a second value indicating a degree of clustering in the at least one of the first or second distributions.

The first distribution may be associated with a first physical layout of the store during the first time period, and the second distribution may be associated with a second physical layout of the store, different from the first physical layout, during the second time period. In an implementation, the method further includes correlating the first distribution to a first value of a sales conversion metric calculated for the first time period, and correlating the second distribution to a second value of the sales conversion metric calculated for the second time period.

In a specific implementation, a method includes collecting first tracking data representing movements of a first set of customers through a first layout of a store, generating a first distribution using the first tracking data, correlating the first distribution to a first value of a sales metric, collecting second tracking data representing movements of a second set of customers through a second layout of the store, different from the first layout, generating a second distribution using the second tracking data, correlating the second distribution to a second value of the sales metric, and comparing the first value of the sales metric to the second value of the sales metric to determine whether to recommend the first layout or the second layout. The sales metric may include sales conversion. The generating a first distribution may include counting a number of customers of the first set of customers who pass by a specific location in the store.

The method may include counting a number of customers of the first set of customers who pass by a specific location in the store to generate the first distribution, and counting a number of customers of the second set of customers who pass by the specific location in the store to generate the second distribution. In an implementation, a number of displays in the first layout is different from a number of displays in the second layout. In an implementation, a location of a display in the first layout is different from a location of the display in the second layout.

In a specific implementation, a method includes collecting a set of tracking data, generating a set of distributions using the set of tracking data, correlating the set of distributions to a set of values of a sales metric, receiving a target distribution associated with a target layout, comparing the received target distribution with the set of distributions to identify a distribution that resembles the target distribution, based on the comparison, determining that a first distribution of the set of distributions resembles the target distribution, and predicting a first value of the sales metric for the target layout, where the first value of the sales metric is correlated to the first distribution.

Comparing the received target distribution with the set of distributions may include calculating a Kullback-Leibler (KL) divergence between a distribution of the plurality of distributions and the target distribution. The set of distributions may include spatial histograms. The sales metric may include sales conversion.

In a specific implementation, a method includes obtaining a set of node sequences that represent paths of customers in a store, each node sequence including a sequence of node indices, each node index identifying a node placed on a floor plan of the store, a point on a path of a customer having been correlated to the node, associating the set of node sequences with a set of consumer behavior patterns, tracking a target customer in the store and generating a target node sequence that represents a current path of the target customer in the store, comparing the target node sequence with the set of node sequences to determine a consumer behavior pattern associated with the target node sequence, and based on the consumer behavior pattern associated with the target node sequence, making a prediction about the target customer.

The method may further include calculating a first string edit distance between the target node sequence and a first node sequence associated with a first consumer behavior pattern, calculating a second string edit distance between the target node sequence and a second node sequence associated with a second consumer behavior pattern, if the first string edit distance is less than the second string edit distance, associating the first consumer behavior pattern to the target customer, and if the second string edit distance is less than the first string edit distance, associating the second consumer behavior pattern to the target customer.

In an implementation, a first consumer behavior pattern of a first node sequence is associated with shoplifting and the method further includes calculating a string edit distance between the target node sequence and the first node sequence, comparing the string edit distance to a threshold value, if the string edit distance is less than the threshold value, associating the first consumer behavior pattern associated with shoplifting to the target customer, and upon the associating, generating a security alert to prevent the target customer from shoplifting.

In an implementation, a first consumer behavior pattern of a first node sequence is associated with not making a purchase and the method further includes calculating a string edit distance between the target node sequence and the first node sequence, comparing the string edit distance to a threshold value, if the string edit distance is less than the threshold value, associating the first consumer behavior pattern associated with not making a purchase to the target customer, and upon the associating, generating an alert for a salesperson to assist the target customer in making the purchase.

The comparing the target node sequence with the set of node sequences may include calculating a Levenshtein distance between the target node sequence and a node sequence of the plurality of node sequences. Making a prediction about the target customer may include predicting that the target customer will shoplift, predicting that the target customer will leave the store without making a purchase, predicting that the target customer will purchase a specific item in the store, predicting that the target customer will purchase a specific quantity of an item in the store, or combinations of these. The store may include a grocery store or a clothing store.

In a specific implementation, a method includes obtaining a set of node sequences that represent paths of customers in a store, each node sequence including a sequence of node indices, each node index identifying a node placed on a floor plan of the store, a point on a path of a customer having been correlated to the node, associating the set of node sequences with a set of consumer behavior patterns, tracking a target customer in the store and generating a target node sequence that represents a current path of the target customer in the store, comparing the target node sequence with the plurality of node sequences to determine a consumer behavior pattern associated with the target node sequence, and based on the consumer behavior pattern associated with the target node sequence, making a prediction about the target customer before the target customer leaves the store.

Comparing the target node sequence with the set of node sequences may include calculating a Levenshtein distance between the target node sequence and a node sequence of the set of node sequences. The prediction may include the target customer will shoplift, the target customer will leave the store without making a purchase, or both. The method may further include generating an alert based on the prediction made about the target customer.

The comparing the target node sequence with the set of node sequences may include calculating a first distance between the target node sequence and a first node sequence of the set of node sequences, calculating a second distance between the target node sequence and a second node sequence of the set of node sequences, if the first distance is less than the second distance, identifying a consumer behavior pattern associated with the first node sequence as being associated with the target node sequence, and if the second distance is less than the first distance, identifying a consumer behavior pattern associated with the second node sequence as being associated with the target node sequence.

Comparing the target node sequence with the set of node sequences may include calculating a first distance between the target node sequence and a first node sequence of the set of node sequences, calculating a second distance between the target node sequence and a second node sequence of the set of node sequences, if the first distance is closer to zero than the second distance, identifying a consumer behavior pattern associated with the first node sequence as being associated with the target node sequence, and if the second distance is closer to zero than the first distance, identifying a consumer behavior pattern associated with the second node sequence as being associated with the target node sequence.

In a specific implementation, a method includes obtaining a set of node sequences that represent paths of customers in a store, each node sequence including a sequence of node indices, each node index identifying a node placed on a floor plan of the store, a point on a path of a customer having been correlated to the node, associating the set of node sequences with a set of consumer behavior patterns, tracking a target customer in the store and generating a target node sequence that represents a current path of the target customer in the store, calculating a Levenshtein distance between the target node sequence and at least a subset of the set of node sequences to determine a consumer behavior pattern associated with the target node sequence, identifying a smallest Levenshtein distance as being between the target node sequence and a first node sequence of the at least a subset of the set of node sequences, and predicting a first consumer behavior pattern for the target customer, where the predicted first consumer behavior pattern is associated with the first node sequence. In an implementation, the prediction is made before the target customer leaves the store.

Other objects, features, and advantages of the present invention will become apparent upon consideration of the following detailed description and the accompanying drawings, in which like reference designations represent like features throughout the figures.

### BRIEF DESCRIPTION OF THE FIGURES

FIG. 1 shows a block diagram of a client-server system and network in which an embodiment of the invention may be implemented.

FIG. 2 shows a more detailed diagram of an example client or computer which may be used in an implementation of the invention.

FIG. 3 shows a system block diagram of a client computer system.

FIG. 4 shows a block diagram of an environment incorporating a system for quantifying customer movement patterns.

FIG. 5 shows an overall flow for quantifying movement pattern.

FIG. 6 shows a schematic of a customer track superimposed over a floor plan of a retail store.

FIG. 7A shows an example of a histogram.

FIG. 7B shows an example of a heat map or kinetic map generated based on the histogram.

FIG. 8 shows a flow for calculating a degree of difference between distributions representing customer movements.

FIG. 9 shows a flow for recommending store layouts.

FIG. 10 shows an example of a store having a first floor plan layout.

FIG. 11 shows an example of the store having a second floor plan layout.

FIG. 12 shows a flow for predictive analytics.

FIG. 13 shows a flow for predicting the behavior of an individual customer.

FIG. 14 shows a schematic of a set of nodes placed on a floor plan of a store.

FIG. 15 shows an example of a customer track.

FIG. 16 shows a schematic of the customer track superimposed over the set of nodes.

FIG. 17 shows a schematic of the customer track correlated to the set of nodes.

FIG. 18 shows an example of node sequences derived from correlated customer tracks.

### DETAILED DESCRIPTION

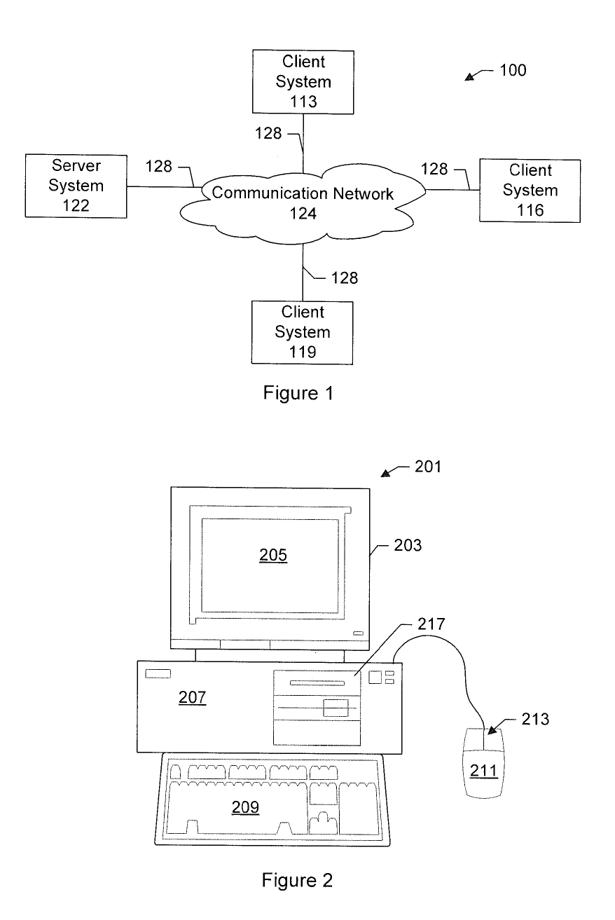

FIG. 1 is a simplified block diagram of a distributed computer network 100. Computer network 100 includes a number of client systems 113, 116, and 119, and a server system 122 coupled to a communication network 124 via a plurality of communication links 128. There may be any number of clients and servers in a system. Communication network 124 provides a mechanism for allowing the various components of distributed network 100 to communicate and exchange information with each other.

Communication network 124 may itself be comprised of many interconnected computer systems and communication links. Communication links 128 may be hardwire links, optical links, satellite or other wireless communications links, wave propagation links, or any other mechanisms for communication of information. Various communication protocols may be used to facilitate communication between the various systems shown in FIG. 1. These communication protocols may include TCP/IP, HTTP protocols, wireless application protocol (WAP), vendor-specific protocols, customized protocols, and others. While in one embodiment, communication network 124 is the Internet, in other embodiments, communication network 124 may be any suitable communication network including a local area network (LAN), a wide area network (WAN), a wireless network, a intranet, a private network, a public network, a switched network, and combinations of these, and the like.

Distributed computer network 100 in FIG. 1 is merely illustrative of an embodiment and is not intended to limit the scope of the invention as recited in the claims. One of ordinary skill in the art would recognize other variations, modifications, and alternatives. For example, more than one server system 122 may be connected to communication network 124. As another example, a number of client systems 113, 116, and 119 may be coupled to communication network 124 via an access provider (not shown) or via some other server system.

Client systems 113, 116, and 119 enable users to access and query information stored by server system 122. In a specific embodiment, a “Web browser” application executing on a client system enables users to select, access, retrieve, or query information stored by server system 122. Examples of web browsers include the Internet Explorer® browser program provided by Microsoft® Corporation, and the Firefox® browser provided by Mozilla® Foundation, and others.

FIG. 2 shows an example client or server system. In an embodiment, a user interfaces with the system through a computer workstation system, such as shown in FIG. 2. FIG. 2 shows a computer system 201 that includes a monitor 203, screen 205, cabinet 207, keyboard 209, and mouse 211. Mouse 211 may have one or more buttons such as mouse buttons 213. Cabinet 207 houses familiar computer components, some of which are not shown, such as a processor, memory, mass storage devices 217, and the like.

Mass storage devices 217 may include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, HD-DVD, or Blu-ray Disc®), flash and other nonvolatile solid-state storage (e.g., USB flash drive), battery-backed-up volatile memory, tape storage, reader, and other similar media, and combinations of these.

A computer-implemented or computer-executable version of the invention may be embodied using, stored on, or associated with computer-readable medium or non-transitory computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software of the present invention may be stored or reside in RAM or cache memory, or on mass storage device 217. The source code of the software may also be stored or reside on mass storage device 217 (e.g., hard disk, magnetic disk, tape, or CD-ROM). As a further example, code may be transmitted via wires, radio waves, or through a network such as the Internet.

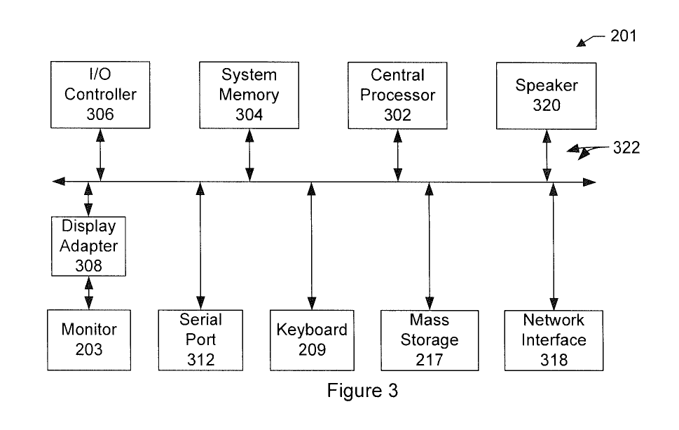

FIG. 3 shows a system block diagram of computer system 201. As in FIG. 2, computer system 201 includes monitor 203, keyboard 209, and mass storage devices 217. Computer system 201 further includes subsystems such as central processor 302, system memory 304, input/output (I/O) controller 306, display adapter 308, serial or universal serial bus (USB) port 312, network interface 318, and speaker 320. In an embodiment, a computer system includes additional or fewer subsystems. For example, a computer system could include more than one processor 302 (i.e., a multiprocessor system) or a system may include a cache memory.

Arrows such as 322 represent the system bus architecture of computer system 201. However, these arrows are illustrative of any interconnection scheme serving to link the subsystems. For example, speaker 320 could be connected to the other subsystems through a port or have an internal direct connection to central processor 302. The processor may include multiple processors or a multicore processor, which may permit parallel processing of information. Computer system 201 shown in FIG. 2 is but an example of a suitable computer system. Other configurations of subsystems suitable for use will be readily apparent to one of ordinary skill in the art.

Computer software products may be written in any of various suitable programming languages, such as C, C++, C#, Pascal, Fortran, Perl, Matlab® (from MathWorks), SAS, SPSS, JavaScript®, AJAX, Java®, SQL, and XQuery (a query language that is designed to process data from XML files or any data source that can be viewed as XML, HTML, or both). The computer software product may be an independent application with data input and data display modules. Alternatively, the computer software products may be classes that may be instantiated as distributed objects. The computer software products may also be component software such as Java Beans® (from Oracle Corporation) or Enterprise Java Beans® (EJB from Oracle Corporation). In a specific embodiment, the present invention provides a computer program product which stores instructions such as computer code to program a computer to perform any of the processes or techniques described.

An operating system for the system may be one of the Microsoft Windows® family of operating systems (e.g., Windows 95®, 98, Me, Windows NT®, Windows 2000®, Windows XP®, Windows XP® x64 Edition, Windows Vista®, Windows 7®, Windows CE®, Windows Mobile®), Linux, HP-UX, UNIX, Sun OS®, Solaris®, Mac OS X®, Alpha OS®, AIX, IRIX32, or IRIX64. Other operating systems may be used. Microsoft Windows® is a trademark of Microsoft® Corporation.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of the system using a wireless network using a protocol such as Wi-Fi (IEEE standards 802.11, 802.11a, 802.11b, 802.11 e, 802.11g, 802.11i, and 802.11n, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

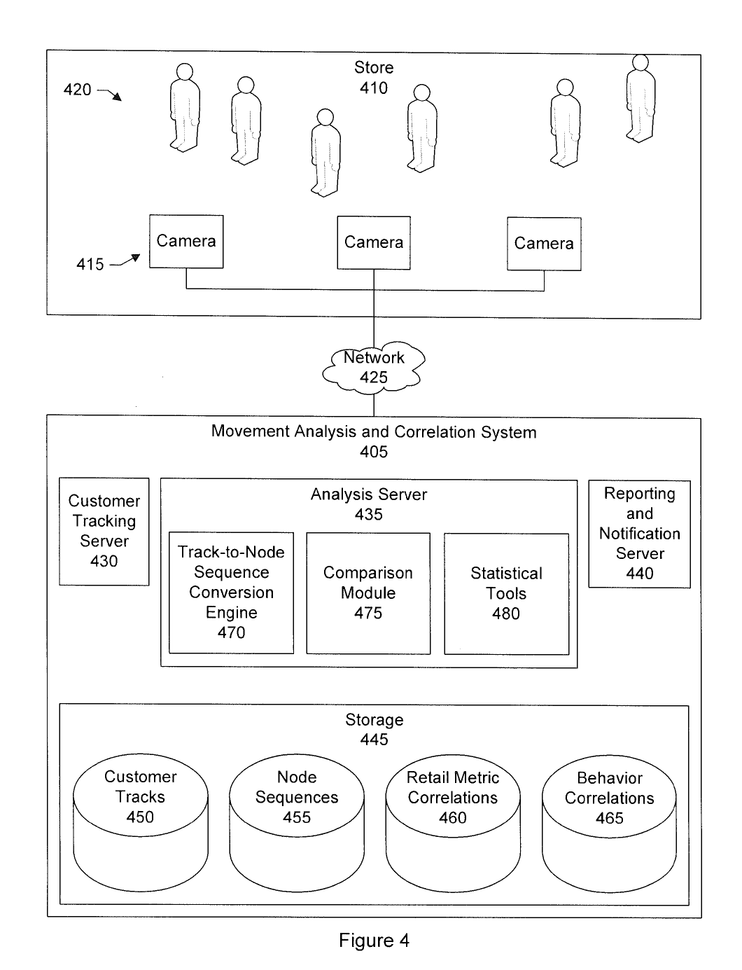

FIG. 4 shows a block diagram of an environment in which a system 405 for analyzing and correlating customer movement to retail metrics (e.g., sales data) may be used. A store 410 includes a set of cameras 415 and subjects 420. The subjects' movements are captured and tracked by the cameras. The cameras are connected via a network 425 to system 405. The system includes a subject or customer tracking server 430, an analysis server 435, a reporting and notification server 440, and storage 445. The storage includes a database 450 to store tracking data, a database 455 to store node sequences, a database 460 to store retail metric correlations, and a database 465 to store consumer behavior pattern correlations.

The network is as shown in FIG. 1 and described above. The servers include components similar to the components shown in FIG. 3 and described above. For example, a server may include a processor, memory, applications, and storage.

In a specific embodiment, the store is a retail space (e.g., “brick and mortar” business) and the subjects are people or human beings. For example, the subjects can include customers, consumers, or shoppers, salespersons, adults, children, toddlers, teenagers, females, males, and so forth. The retail space may be a grocery store, supermarket, clothing store, jewelry store, department store, discount store, warehouse store, variety store, mom-and-pop, specialty store, general store, convenience store, hardware store, pet store, toy store, or mall—just to name a few examples.

A feature of the system provides, given a set of movement traces (i.e., locations over time) for customers in a retail environment, quantifying movement patterns in several ways. The system can use these quantifications to correlate with other retail metrics (e.g., sales data), consumer behavior, or both to determine which patterns are conducive to positive results for the retailer. In a specific implementation, the movement or tracking data is placed into various data structures (e.g., spatial histogram or star graph). The system derives a set of metrics related to the data structures. Each metric can be a single numerical result that quantifies movement patterns in some unique way. Taken together, these metrics help to describe the movement pattern under examination.

A specific implementation of the system is referred to as RetailNext from RetailNext, Inc. of San Jose, Calif. This system provides a comprehensive in-store analytics platform that pulls together a comprehensive set of information for retailers to make intelligent business decisions about their retail locations and visualizes it in a variety of automatic, intuitive views to help retailers find those key lessons to improve the stores. The system provides the ability to connect traffic, dwell times, and other shopper behaviors to actual sales at the register. Users can view heat maps of visitor traffic, measure traffic over time in the stores or areas of the stores, and connect visitors and sales to specific outside events. The system can provide micro-level conversion information for areas like departments, aisles, and specific displays, to make directly actionable in-store measurement and analysis.

The tracking server is responsible for tracking customers as they move throughout the store. The tracking server can track a particular customer as the customer moves across the different camera views of each camera. A track is a path that a customer followed during the customer's visit to the store. Tracking data is collected and stored in tracking database 450.

The analysis server includes a conversion engine 470, a comparison module 475, and statistical tools 480. The conversion engine is responsible for converting a track stored database 450 into a node sequence for storage in database 455. A node sequence represents an abstraction of the path that the customer followed while in the store. The node sequence includes an ordered set of node indices. Each node index corresponds to a node that is placed at a location on a floor plan of the space. Further discussion of node sequences is provided below.

The comparison module can compare one node sequence to another node sequence. The comparison can be used to identify common movement patterns, different movement patterns, frequent movement patterns, outlier movement patterns, facilitate machine learning, or combinations of these. The statistical tools include a package of statistical tools to help quantify and analyze movement patterns. In a specific implementation, a statistical analysis performed by the system includes calculating a Kullback-Leibler (KL) divergence, entropy, Ripely's K, a string edit or Levenshtein distance, or combinations of these.

Database 460 stores correlations between sales data, key performance indicators (KPI)s, and other retail metrics to customer movement patterns. Retail metrics or sales data may be imported from an external system such as point of sales (POS) device, an inventory management system, customer relationship management (CRM) system, financials system, warehousing system, or combinations of these. In a specific implementation, a retail metric includes conversion data or a conversion rate. A conversion can be expressed as a percentage of customers that enter the store and purchase a good, service, or both. The conversion can be calculated by dividing a number of sales transactions by a number of customers who enter the store. Conversion measures the amount of people who enter store versus the number of customers who make a purchase. Conversion helps to provide an indication of how effective the sales staff is at selling products and the number of customers visiting the store.

Conversions can be for any time period such as an hour, day, week, month, quarter (e.g., fall, winter, spring, or summer), year, and so forth. A conversion may be calculated for a particular day such as a weekday (e.g., Monday, Tuesday, Wednesday, Thursday, Friday, Saturday, or Sunday), a weekend (e.g., Friday, Saturday, or Sunday), a holiday (e.g., Columbus Day, Veterans Day, or Labor Day), the day following Thanksgiving (e.g., Black Friday), and so forth.

Some other examples of metrics include traffic to a particular location in the store (e.g., traffic past a particular display), engagement (e.g., measurement of how well sales staff is engaging customers), sales per square foot, comparable-store sales (e.g., year-over-year sales performance), average sale per customer or transaction, cost of goods sold, markup percentage, inventory to sales ratio, average age of inventory, wages paid to actual sales, customer retention (e.g., number of repeat purchases divided by number of first time purchases), product performance (e.g., ranked listing of products by sales revenue), sales growth (e.g., previous period sales revenue divided by current period sales revenue), demographic metrics (e.g., total revenue per age, sex, or location), sales per sales associate (e.g., actual sales per associate per time period), or average purchase value (e.g., total sales divided by number of sales)—just to name a few examples.

The reporting and notification server is responsible for displaying reports and results from the data analysis, and generating and sending notifications and alerts. Results from the analysis may be displayed on graphical user interface (GUI), printed on paper, or both. The displayed results may include graphs (e.g., line graphs), charts (e.g., pie chart, bar chart, or area graphs), tables, text, or combinations of these. A notification or alert may include a text message (e.g., simple message service (SMS) message, or multimedia message service (MMS) message), email, phone call (e.g., recorded voice call), instant message (IM), or combinations of these.

Database 465 stores correlations between customer movement patterns and consumer behavior or actions. Actions that a customer may take inside the store include making a purchase, not making a purchase, shoplifting, talking to a salesperson, not talking to a salesperson, using a fitting room, not using a fitting room, pausing in front of display, walking past a display, and the like.

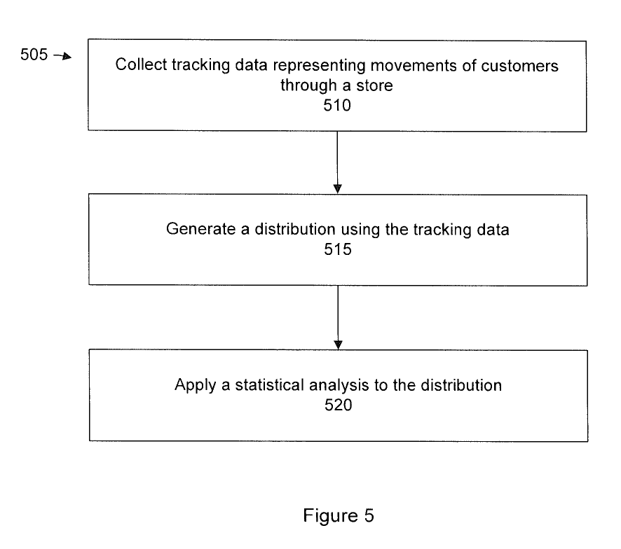

FIG. 5 shows an overall flow 505 for quantifying customer movement patterns. Some specific flows are presented in this application, but it should be understood that the process is not limited to the specific flows and steps presented. For example, a flow may have additional steps (not necessarily described in this application), different steps which replace some of the steps presented, fewer steps or a subset of the steps presented, or steps in a different order than presented, or any combination of these. Further, the steps in other implementations may not be exactly the same as the steps presented and may be modified or altered as appropriate for a particular process, application or based on the data.

In a step 510, the system collects tracking data representing movements of customers through a store. In a specific implementation, the tracking data includes an a collection of individual tracks, each individual track representing a single customer's path through the store as the person moves from camera view to camera view through the store. The collected tracks can be combined or aggregated for a macro analysis. U.S. patent application Ser. No. 13/603,832 (the '832 application), filed Sep. 5, 2012, which is incorporated by reference along with all other references cited in this patent application, describes techniques for obtaining a first subtrack of a customer captured by a first camera in the store, obtaining a second subtrack of the customer captured by a second camera in the store, and matching the first and second subtracks to join them together as a single track.

As discussed in the '832 application, a method to obtain the track includes projecting track data from each camera into a single unified coordinate space (e.g., “real space”), and matching and joining tracks belonging to a single tracked customer. In an implementation, tracking data includes a set of time-stamped points, each point being mapped to a position or location on a floor of the store. A point may be specified in a Cartesian coordinate system. For example, a point can include a pair of coordinates (e.g., an X-coordinate and a Y-coordinate). In an implementation, a track is defined by a set of points. Each point includes an X-coordinate value and a Y-coordinate value. The X-coordinate value represents a customer's position with respect to an X-axis. The Y-coordinate value represents the customer's position with respect to a Y-axis. Further discussion is provided in the '832 application.

In a step 515, the system generates a distribution using the tracking data. In a specific implementation, the distributions include spatial histograms. In this specific implementation, the tracking or movement data is placed into a data structure known as a spatial histogram. The spatial histogram can represent how much movement there is in the different locations in the store. Such a histogram is initialized with a set of “bins” or areas in two-dimensional space. These bins may vary in size from histogram to histogram, but are uniform within a single histogram and can be placed along a simple grid. Each point in a movement trace can then be added to a bin in this histogram.

In this specific implementation, the histograms are 3-dimensional. The x and y axes represent x,y locations inside the store. The z axis represents frequencies at these locations. The space is made discrete by aggregating across x,y locations. For example, x values from 1-5 might be one “bin” with x values from 6-10 being the next “bin” and so on. The amount of aggregation is then represented by the size of the bin (“5” in the example above). For the sake of simplicity, the histogram can be treated as 2-dimensional by lining up each bin along the x axis, as discussed above. So, the x axis would show locations (e.g., {0,0},{1,0},{1,1} and so on) with the y axis showing frequencies. Given the bins as described, a track is correlated to the bin locations it visits. For each point in the track, 1 is added to the corresponding bin location for that point.

The histogram therefore represents the aggregate movement pattern for some period of time. It should be appreciated that movement traces can be further segmented before being added to the histogram—e.g., a histogram might represent only movement traces at some particular time of day, or where customers are moving quickly, or any other criteria. In other words, in a specific implementation, the tracking or movement data is converted into a multinomial. The multinomial is a probability distribution with a set of bins. Each bin represents a location on the floor of the store. The distribution provides a probability of a person being at the location.

Generally, a histogram is a graphical representation showing a visual impression of the distribution of data. It is an estimate of the probability distribution of a continuous variable. A histogram includes tabular frequencies, shown as adjacent rectangles, erected over discrete intervals (bins), with an area equal to the frequency of the observations in the interval. The height of a rectangle is also equal to the frequency density of the interval, i.e., the frequency divided by the width of the interval. The total area of the histogram is equal to the number of data. A histogram may also be normalized displaying relative frequencies. It then shows the proportion of cases that fall into each of several categories, with the total area equaling 1. The categories are usually specified as consecutive, non-overlapping intervals of a variable. Generally, a multinomial is the histogram, as described above, transformed into a probability distribution. This transformation includes listing each bin location in a way similar to the 2-D representation above, along with a probability for that bin. The probability of a particular bin is the number of points in that bin (the frequency) divided by the total number of points in all bins in the histogram.

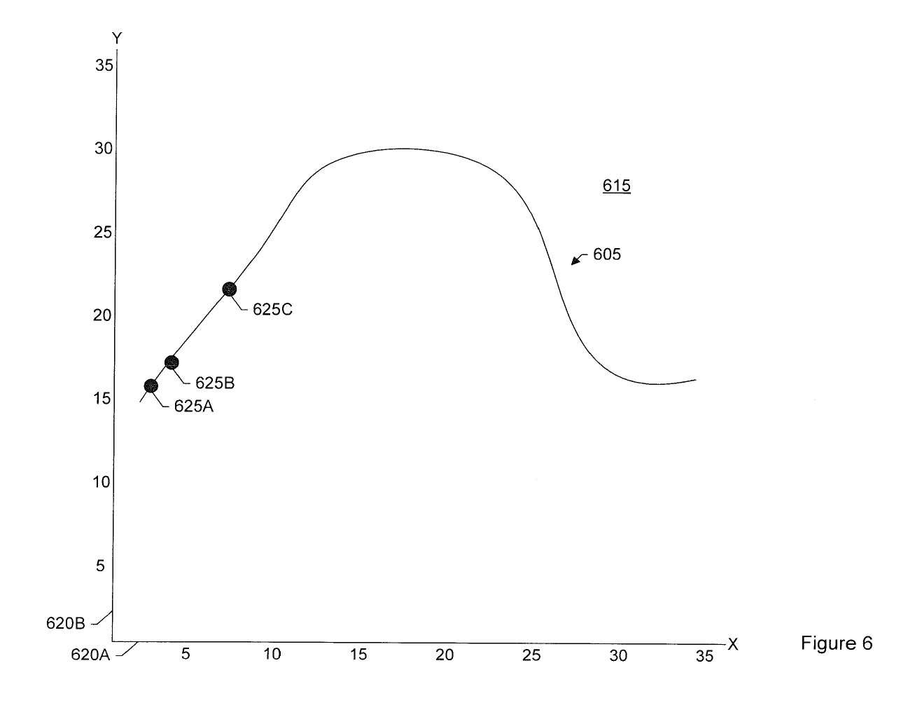

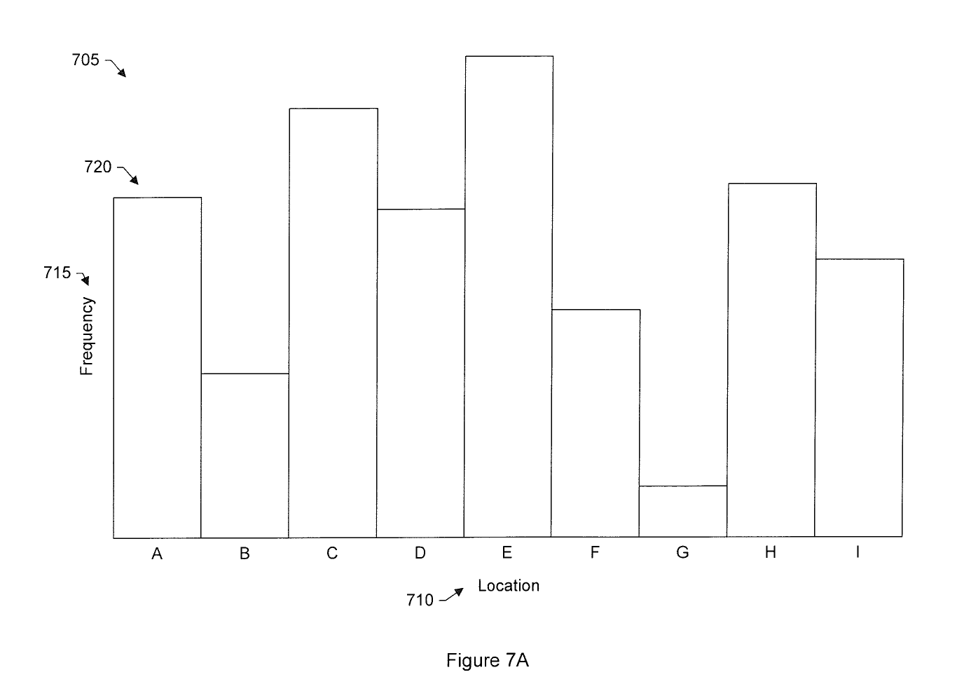

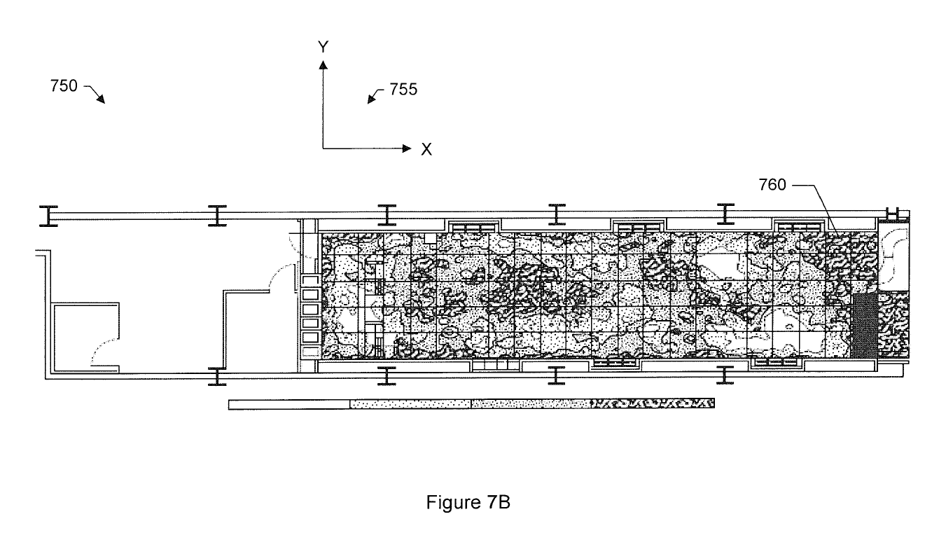

More particularly, consider as an example FIGS. 6 and 7A. FIG. 6 shows a movement trace or track plotted on a floor plan of the store. FIG. 7A shows an example of a histogram that may be generated using the movement trace. Referring now to FIG. 6, a first track or movement trace 605 is shown overlaid on a floor plan 615 of the store. In this example, the floor plan has been mapped into an X-Y or Cartesian coordinate space. Thus, locations on the floor plan can be specified using an X-Y coordinate system. The origin of the X-Y coordinate system can be at any arbitrary location on the floor plan such as at a corner. An X-axis 620A indicates an X-coordinate of a point on a track. A Y-axis 620B indicates a Y-coordinate of the point on the track. For example, a point 625A on the first track has the coordinates (2, 17), a point 625B on the first track has the coordinates (3, 18), a point 625C on the first track has the coordinates (7, 22). X-axis 620A and Y-axis 620B may be defined using any unit of length (e.g., centimeters, millimeters, inches, and so forth). A point may be time-stamped to indicate the time at which the customer was tracked or detected at the particular point. Table A below shows the tracking data in tabular format.

TABLE A

| Point | Coordinates |
|---|---|
| 625A | (2, 17) |
| 625B | (3, 18) |
| 625C | (7, 22) |
| . . . | . . . |

The tracking data can be analyzed and summarized into a frequency table. The frequency table can show a count, tally, or total number of customers passing by a particular location or area in the store during a particular time period. Each point on a track may be mapped to a corresponding location on the floor plan. The system can determine a number of customers passing by a location in the store during a time period by correlating the tracking point coordinates with the location and correlating the tracking point timestamps with the time period. For example, the system can determine a number of customers who passed by a particular location in the store during the time period 2:00 p.m.-2:59 p.m. by identifying which tracking coordinate points fall within the location during the time period from 2:00 p.m.-2:59 p.m.

Table B below shows an example frequency table that may be derived from the tracking data. A first column of the table lists the locations. The locations can be represented as bins of a histogram. A second column includes a count of the number of customers that visited that particular location.

TABLE B

| Bin | Count |
|---|---|
| A | 85 |
| B | 62 |
| C | 107 |
| D | 81 |
| E | 120 |
| F | 56 |
| G | 12 |
| H | 87 |
| I | 68 |

In this example, each bin corresponds to a particular location, region, or area in the store. For example, a first bin A corresponds to a first location in the store. First bin A is associated with a first counter variable which, in this example, has a value of “85.” This indicates that the number customers who visited the first location is 85. A second bin B corresponds to a second location in the store. Second bin B is associated with a second counter variable which, in this example, has a value of “62.” This indicates that the number of customers who visited the second location is 62, and so forth.

A floor plan of a store may be divided up into any number of locations, regions, or areas depending upon the desired sensitivity or precision. Having more locations rather than fewer locations can provide a very fine and granular analysis. Too many locations, however, may put the focus on random variations because of the small number of data points within the location. Conversely, having fewer locations can help reduce the number of random variations. Too few locations, however, can cause important data points to be overlooked. The appropriate number of locations will depend upon the situation and application of the system. In an implementation, areas of the locations are the same. That is, an area of the first location in the store may be equal to an area of the second location in the store. An area may be specified in square centimeters, square meters, square feet, square inches, or any other unit of area as desired. In another specific implementation, areas of the locations may be different.

The boundaries of a location in a store may be defined by a set of points and vectors or segments between each point of the set of points. For example, the first location may be defined by a first vector extending between a first and a second point, a second vector extending between the second and a third point, a third vector extending between the third and a fourth point, and a fourth vector extending between the fourth and first point. A shape of a region bounded by a set of points and vectors may be a square, rectangle, triangle, or any other shape as desired. The shape can be a closed polygon. Alternatively, the shape can include curved line segments such as a circle, oval, or kidney-shape (e.g., including convex and concave lines).

FIG. 7A shows an example of a histogram 705 that may be generated from the frequency table. The histogram includes a X-axis 710, a Y-axis 715, and a set of bins 720. The X-axis identifies locations within the store. The Y-axis identifies the frequency of observations at a location.

The histogram of the frequency distribution can be converted to a probability distribution by dividing the tally in each group by the total number of data points to give the relative frequency. The distribution can be a discrete probability distribution. The mathematical definition of a discrete probability function, p(x), is a function that satisfies the following properties. A first property is the probability that x can take a specific value is p(x). That is, P[X=x]=p(x)=pₓ. A second property is that p(x) is non-negative for all real x. A third property is that the sum of p(x) over all possible values of x is 1, that is ΣPⱼ=1, where j represents all possible values that x can have and pⱼ is the probability at xⱼ.

In a specific implementation, a method for organizing tracking data includes dividing a floor plan of a store into a set of locations. That is, a set of locations is established on the floor plan or ground plane of the store. Each location is associated with a counter. A set of tracks are received. Each track represents movement of a person through the store. Each track is defined by a set of points. In this specific implementation, the method further includes determining whether a first point of a first track falls within a first location, and, if the first point falls within the first location, incrementing a counter associated with the first location. The method may include if the first point falls outside the first location, not incrementing the counter associated with the first location. A point of a track may include an x-coordinate and a y-coordinate. A location may be defined by a set of coordinates and vectors extending between the set of coordinates. Any technique may be used to determine whether a point on a track falls within (or falls outside) a particular location region defined by the set of coordinates and vectors. For example, computational geometry may be used to determine whether a point falls inside or outside a boundary of a particular location.

FIG. 7B shows an example of a heat map 750 that may be generated based on the histogram. A heat map (which may be referred to as a “kinetic map”) is an example of one particular visualization of the histogram. A heat map is a graphical representation of data where the individual values contained in a matrix are represented as colors. In a specific implementation, this is done by showing x,y coordinates as a grid representative of an x,y space 755. Frequency is shown as a color drawn on that grid. For example, bins with more points may be shown as red, while bins with fewer points may be shown in blue, and so forth. A color of a particular gird element, such as a grid element 760 can be based on a number of customers there were detected at the grid element. A location and area size of a gird element can be defined using x,y coordinates. The gird element can be represented as a bin of a histogram. The heat map can include a legend.

Referring now to FIG. 5, in a step 520, statistical analyses are applied to the distributions in order to calculate metrics that describe the movement pattern under examination. In a specific implementation, a metric includes calculating a Kullback-Leibler (KL) divergence. A KL-divergence is a non-symmetric measure of the difference between two probability distributions P and Q.

In this specific implementation, “background” spatial histogram is derived using a dataset that is deemed indicative of “normal” or that represents some behavior pattern that we are interested in comparing future patterns to. Then, each new histogram can be compared to this background histogram using KL-divergence computed over corresponding bins in the two histograms. KL-divergence describes the difference of the target histogram to the background. The K-L divergence of distribution Q from distribution P is defined as:

$${D}_{KL} ( P \vert \vert Q ) = {\sum }_{i} P ( i ) log \frac{P ( i )}{Q ( i )}$$

For example, we might derive a background histogram from a month of movement traces. We might then wish to know which days are most “normal” (low KL-divergence) and which are most unusual (high KL-divergence). The background histogram may be referred to as a reference histogram. A histogram compared to the reference histogram may be referred to as a target histogram.

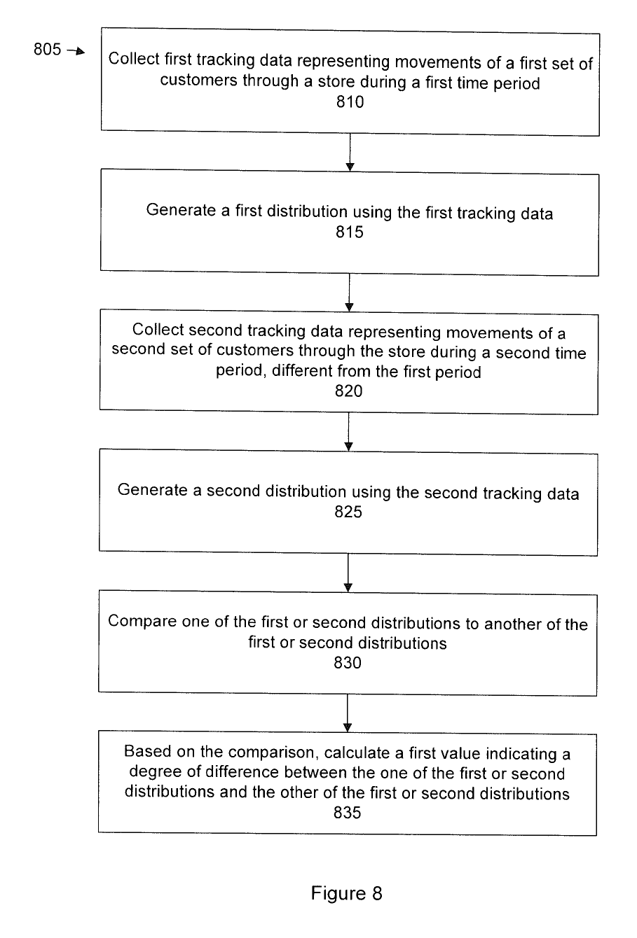

FIG. 8 shows a flow 805 for calculating a degree of difference between two distributions. A step 810 includes collecting first tracking data representing movements of a first set of customers through a store during a first time period. The first time period can be of any duration of time (e.g., 1 hour, 2 hours, 3 hours, 5 hours, 8 hours, 10 hours, 12 hours, 24 hours, 1 day, 2 days, 3 days, 1 week, 2 weeks, 1 month, 2 months, 6 months, 1 year, and so forth). A step 815 includes generating a first distribution using the first tracking data.

A step 820 includes collecting second tracking data representing movements of a second set of customers through the store during a second time period, different from the first time period. The first and second time periods may be non-overlapping time periods. One of the first or second time periods may occur before the other of the first or second time periods. One of the first or second time periods may occur after the other of the first or second time periods. The first and second time periods may or may not be consecutive time periods. The first and second time periods may have the same duration or different durations. One of the first or second time periods may have a duration that is longer than another of the first or second time periods. One of the first or second time periods may have a duration that is shorter than another of the first or second time periods. The first and second time periods may be different days of a week. The first and second time periods may be the same day of different weeks.

A step 825 includes generating a second distribution using the second tracking data. Generating the tracking data and generating the first and second distributions may be as shown in steps 510 and 515 of FIG. 5 and described in the discussion accompanying FIG. 5.

A step 830 includes comparing one of the first or second distributions to another of the first or second distributions. A step 835 includes based on the comparison, calculating a first metric or first value (e.g., KL-divergence) indicating a degree of difference between the one of the first or second distributions and the other of the first or second distributions. One of the first or second distributions may be identified as a background, normal, or reference distribution. The other of the first or second distributions may be identified as the examined distribution or target distribution.

Referring now to FIG. 5 (step 520), in another specific implementation, a statistic analysis of the distributions or metric includes calculating entropy. Entropy describes the amount of randomness in a spatial histogram. A histogram with low entropy generally has movement that is centered in just a few areas, while one with high entropy will have movement evenly distributed across many areas. Entropy may be defined as:

$$H ( X ) = - {\sum }_{i = 1}^{n} p ( {x}_{i} ) log ( p ( {x}_{i} ) )$$

Note that entropy fails to take into account the spatial adjacencies between bins, instead treating each bin as an independent sample. Therefore, a low entropy distribution will have all of its activity centered in a small number of bins, but those bins might be adjacent or they might not be—entropy fails to capture that difference. The Ripley's K statistic captures spatial adjacencies between bins. Each of the statistics described (e.g., KL-divergence, entropy, and Ripley's K) capture different features of the data.

In another specific implementation, a metric includes calculating Ripley's K. Ripley's K is a statistic often used in epidemiology to describe how clustered disease outbreaks are. In this context, we would like to know how clustered customer movement is in the store. Unlike entropy, Ripley's K utilizes information about the locations of bins and the relationships between bins. Ripley's K may be defined as:

$$\hat{K} ( s ) = {λ}^{- 1} {n}^{- 1} {\sum }_{i \neq j} I ( {d}_{ij} < s )$$

A high Ripley's K value indicates a movement pattern that is highly focused on a few areas of the store, while a low value indicates that customer movement is spread across many areas. Taken together with entropy, Ripley's K gives a clear view of the degree to which particular locations matter in the context of a set of movement traces. For example, if a store is running a few promotional displays, they might hope to see a high Ripley's K value, which would show movement clustered in a few areas (presumably the areas with promotional displays). A low value might mean that people are failing to cluster appropriately around the displays as the store had hoped.

In a specific implementation, after computing each of the above metrics for some set of movement data, the system can be used to derive the target metric for that same dataset. This may be, for example, total sales for the period of time represented in the movement data. A Pearson's R for each metric above can be computed as it relates to the target metric. Pearson's R describes the degree to which two sets of points are correlated, or how closely their movement mimics each other. A high (positive) value for Pearson's R for a month of KL-divergence points (taken as one day samples) compared to sales data would tell us, for example, that days that have unusual movement patterns lead to high sales, while “normal” days tend to have lower overall sales.

Given these correlations, the system facilitates several forms of further analysis. Such analysis can include looking for outliers, or days that do not fit the patterns and trying to determine why they do not fit. Other examples of analysis includes looking for the reasons these patterns exist in order to further encourage (or inhibit) the effects of these patterns. In a specific embodiment, these analyses are not automatic and are done adhoc by trained analysts with extensive knowledge of retail and the influence of various parameters on customer movement and sales.

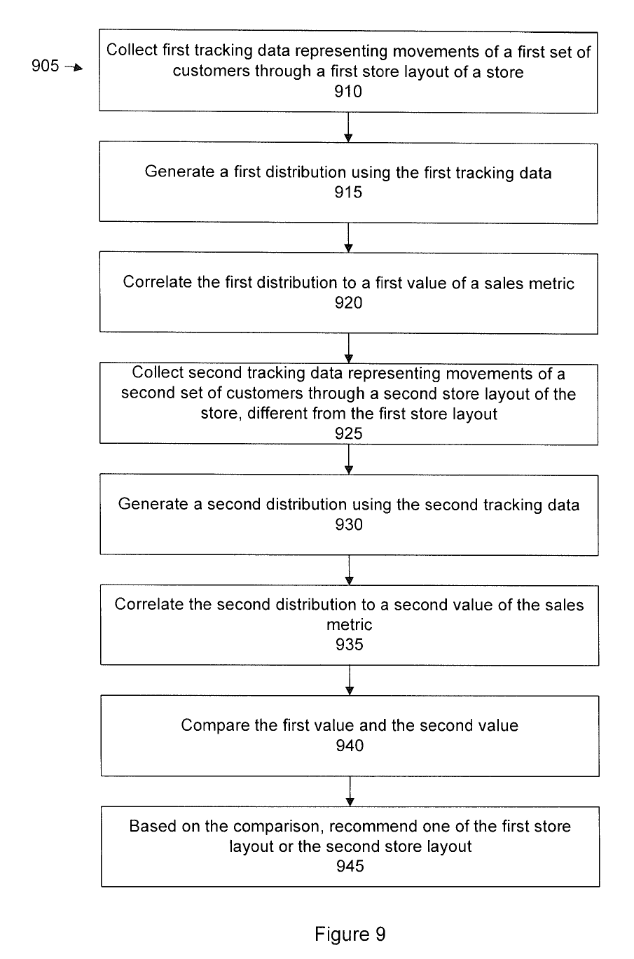

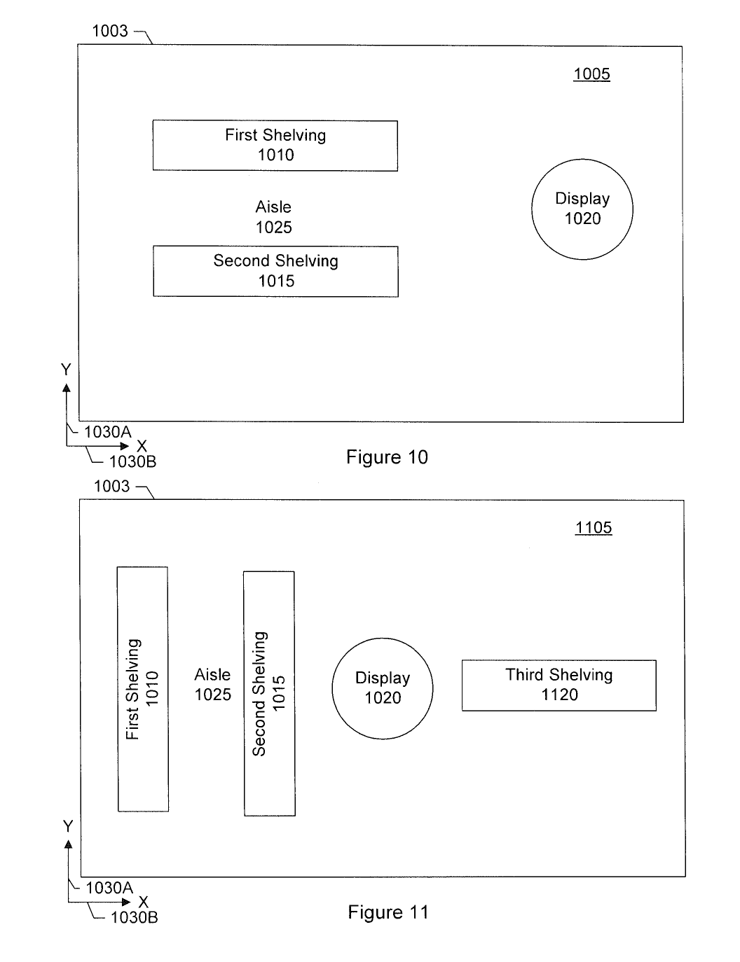

FIG. 9 shows a flow 905 of a specific application of quantifying movement patterns. In this specific implementation, quantifying movement patterns allows the retailer to compare the effect of different physical store layouts with respect to a sales metric (e.g., conversion rate). In a step 910, the system collects first tracking data representing movements of a first set of customers through a first store layout of a store. For example, FIG. 10 shows an example of a store 1003 having a first floor plan layout 1005. The first floor plan layout includes first and second shelving 1010 and 1015, respectively, and a display 1020. The first and second shelving form an aisle 1025. The floor plan has been mapped into an X-Y coordinate space having an X-axis 1030A and a Y-axis 1030B perpendicular to the X-axis. In the first floor plan layout, the first and second shelves are parallel to each other and the X-axis. The first and second shelves are perpendicular to the Y-axis. The first shelving is above the second shelving. The second shelving is below the first shelving. The display is offset to a right side of the shelving. A length of the first shelving is the same as a length of the second shelving.

In a step 915 (FIG. 9), a first distribution is generated using the first tracking data. In a step 920, the first distribution is correlated to a first value of a sales metric. In a step 925, the system collects second tracking data representing movements of a second set of customers through a second store layout of the store.

In a step 930, a second distribution is generated using the second tracking data. In a step 935, the second distribution is correlated to a second value of the sales metric. Collecting the tracking data and generating the distributions is as shown in steps 510 and 515 in FIG. 5 and described in the discussion accompanying FIG. 5. FIG. 11 shows an example of the store having a second floor plan layout 1105, different from the first floor plan layout. For example, in the second floor plan layout as compared to the first floor plan layout, the first and second shelving have been arranged so that they are parallel to the Y-axis and perpendicular to the X-axis. The second floor plan layout includes an additional third shelving unit 1120. A number of shelving units in second floor plan layout is different from a number of shelving units in the first floor plan layout. The number of shelving units in the second floor plan layout is greater than the number of shelving units in the first floor plan layout. The number of shelving units in the first floor plan layout is less than the number of shelving units in the second floor plan layout. The display has been moved to the left so that the display is positioned between the second shelving and the third shelving.

In a step 940, the first and second values are compared. In a step 945, based on the comparison, a recommendation is made for one of first or second store layouts. Store layouts have strong effect on the foot traffic through the store. Generally, it will be desirable to have a layout that invites movement and traffic flow through the store. A good layout allows a retailer to achieve good sales metrics such as rates of conversions, sales per square foot, and others. Quantifying movement patterns and correlating movement patterns to sales metrics helps retailers select store layouts that have positive effects on the metrics. Conversely, quantification allows retailers to avoid layouts that have negative effects. With the system, retailers can experiment with different store layouts and select that layout having the desired sales effect.

For example, a retailer may be looking for a store layout that correlates well (either positively or negatively) with conversion. This can mean choosing the layout with the highest Pearson's R for KL-divergence versus conversion. Another example might be looking for the layout that generates the most sales. In this example, the retailer may choose based on the highest overall sales number. These are merely examples that have been simplified for ease of understanding the principles of the invention. It should be appreciated that the system is capable of performing far more sophisticated statistical analysis taking into account one, two, three, or more than three dependent variables and complex selection criteria. For example, a retailer may desire more than simply choosing a layout. The system can help facilitate an understanding of how various properties of specific layouts (represented by the spatial statistics KL, Ripley's, entropy) affect the key performance indicators (KPI's) that the retailer is interested in (e.g., overall sales and conversion).

Differences between one layout and another layout can include differences related to numbers of shelves, types of shelves (e.g., wall mounted, free standing, wire shelving, or gondola shelving), shelf material (e.g., metal, wood, glass, or plastic), shelf design and style (e.g., color), location and arrangement of shelves, displays, number of displays, types of displays, display cases, number of display cases, types of display cases, shelf and display size, show cases, wall cases, display platforms, canopies, display racks (e.g., clothing display racks, wine display racks, or product display racks), counters, counter locations, counter size, counter shapes (e.g., rectangular, circular, oval, or square), fixtures, lighting (e.g., recessed lighting, wall sconces, fluorescent, incandescent, or track), wall coverings, wall paneling, floor coverings (e.g., linoleum, tile, concrete, epoxy, or carpet), mannequins, number of mannequins, spaces, or visibility—just to name a few examples.

In a specific implementation, a method includes collecting first tracking data representing movements of a first set of customers through a first store layout of a store, generating a first distribution using the first tracking data, correlating the first distribution to a first value of a sales metric, collecting second tracking data representing movements of a second set of customers through a second store layout of the store, generating a second distribution using the second tracking data, correlating the second distribution to a second value of the sales metric, comparing the first value of the sales metric to the second value of the sales metric, and based on the comparison, recommending one of the first store layout or the second store layout.

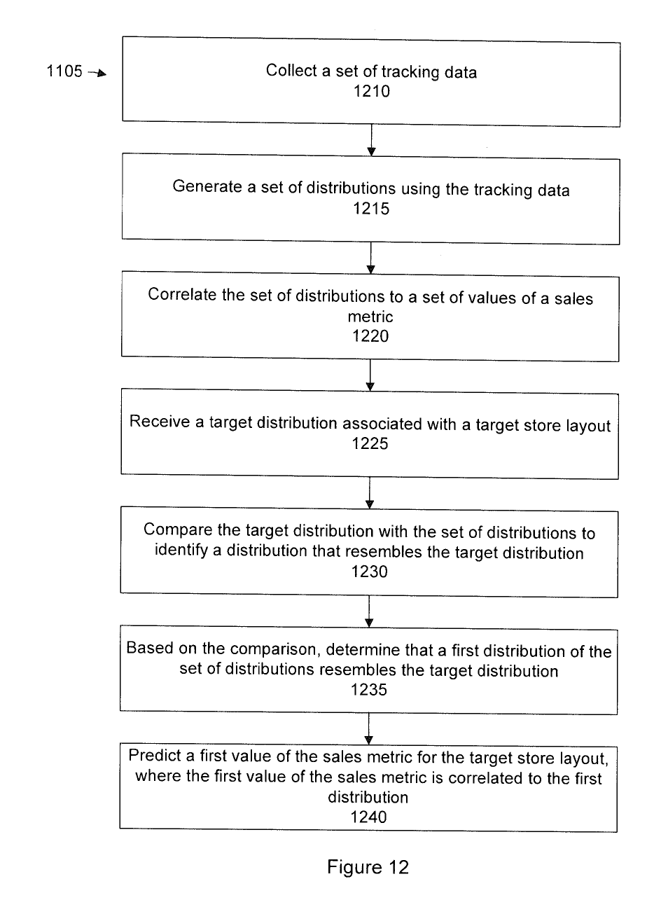

FIG. 12 shows an overall flow 1205 for predicting sales metrics. An example of prediction includes a linear prediction. A linear prediction may include performing a linear regression using two variables of interest (e.g., KL and sales). The system can then predict one variable given the other by utilizing the regression line. There can be other more sophisticated forms of prediction. Prediction may include techniques for machine learning and artificial intelligence.

In a step 1210 the systems collects a set of tracking data. In a step 1215 the systems generates a set of distributions using the tracking data. In a step 1220 the distributions are correlated to a set of values of a sales metric. In a specific implementation, the sales metric is conversion. It should be appreciated, however, that correlations may be with other sales metrics discussed above. Collecting the tracking data and generating the distributions are as shown in steps 510 and 515 of FIG. 5 and described in the discussion accompanying FIG. 5.

In a step 1225, the system receives a target distribution associated with a target store layout. In a specific implementation, the target distribution represents an expected distribution pattern when the store has the target layout. In a specific implementation, a user, such as an administrator, uploads the target distribution pattern to the system. In another specific implementation, the system provides a tool for the user to create the target distribution pattern.

In a step 1230, the system compares the target distribution with the set of distributions to identify a distribution that resembles the target distribution. In a specific implementation, the comparison includes calculating KL-divergence to determine a degree of difference between the target distribution and the distribution.

In a step 1235, based on the comparison, the system determines that a first distribution of the set of distributions resembles the target distribution. The determination may include selecting that distribution whose KL-divergence value against the target distribution is zero or closest to zero. In a step 1240, the system predicts a first value of the sales metric for the target store layout, where the first value of the sales metric is correlated with the first distribution.

In a specific implementation, the above flow is used to predict the impact that changes in store layout will have on sales metrics. The system allows retailers to create that traffic pattern that is conducive to good sales metrics (e.g., conversion rates). For example, based on the results from the system, a retailer may relocate a display in a store from a first location in the store to a second location in the store, different from the first location, add a display to the store, move a display table, or make other layout changes. Predictions of sales metrics can be based on traffic patterns, time periods (e.g., time of year), weather, number of staff, and other factors. The system can help retailers to identify the type of traffic patterns that will be predictive of good sales metrics.

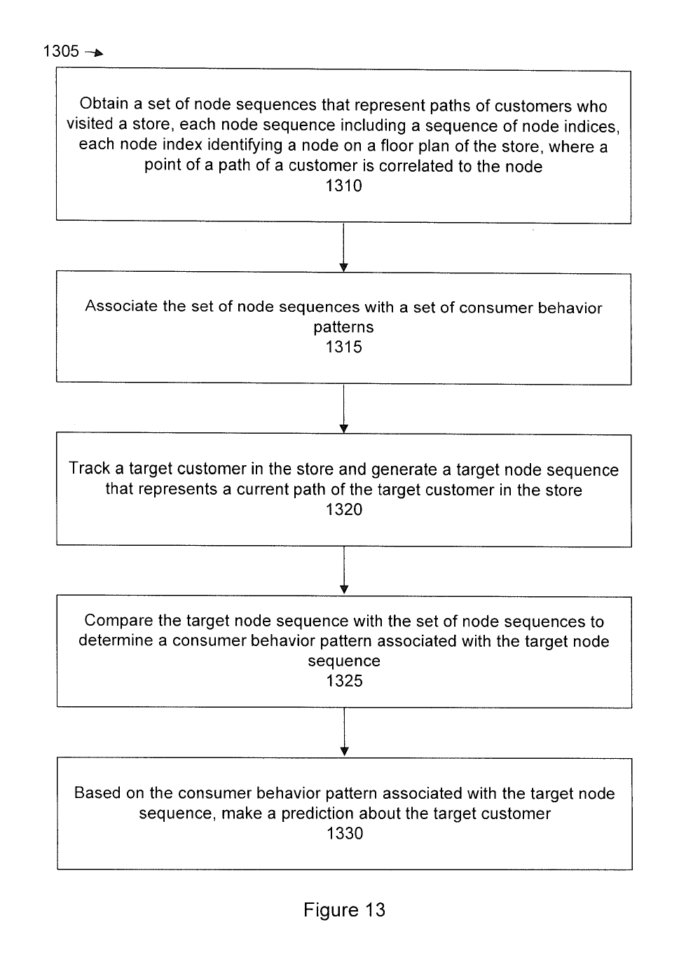

FIG. 13 shows an overall flow 1305 for predicting the behavior of an individual customer based on the behavior of past customers who had movement patterns similar to the individual customer. In a step 1310, the system obtains, receives, or generates a set of node sequences that represent paths or tracks of customers who visited a store. Each node sequence can include a sequence of node indices. Each node index can identify a node that has been placed or established on a floor plan of the store. A point on a path of a customer is correlated to the node. In other words, each node sequence can include a sequence of node indices, each node index having been assigned to a corresponding node on a floor plan of the store, the corresponding node having been correlated to a point on a path of a customer.

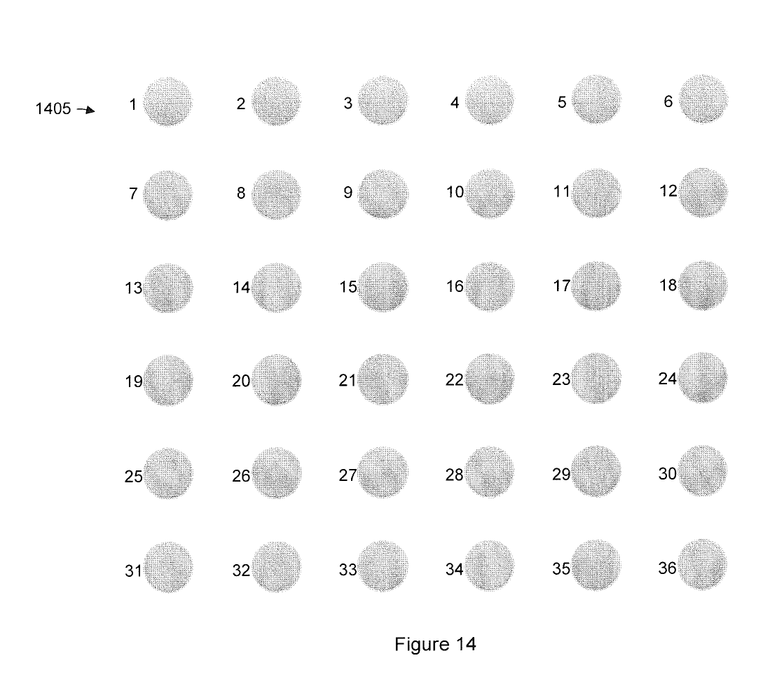

FIGS. 14-17 show schematics of a technique for obtaining the node sequences. In a specific implementation, nodes are placed in one of three ways. A first placement technique includes placing nodes based on density of traffic. A second placement technique includes placing nodes uniformly as a grid. A third placement technique includes manually at specific locations of interest. In some cases, the third placement technique is desirable in retail analysis since nodes can be placed at specific displays and other important areas (e.g., the point of sale (POS)) to understand movement around those areas. Nodes may be placed uniformly or non-uniformly.

In an implementation, the number of nodes (along with node placement) generally relates to the type of question to answer. For example, if the retailer is interested in coarse traffic patterns (e.g., do customers tend to go right or left upon entering the store?) fewer nodes can be more useful, while for finer traffic patterns (e.g., do customers visit this display first or that one?) more nodes may be desirable.

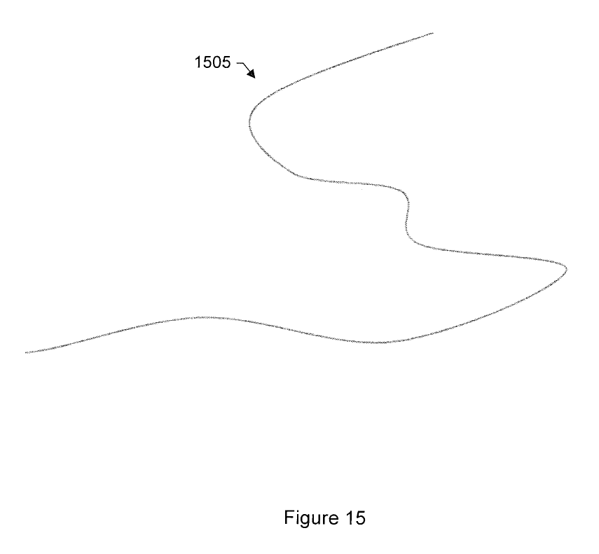

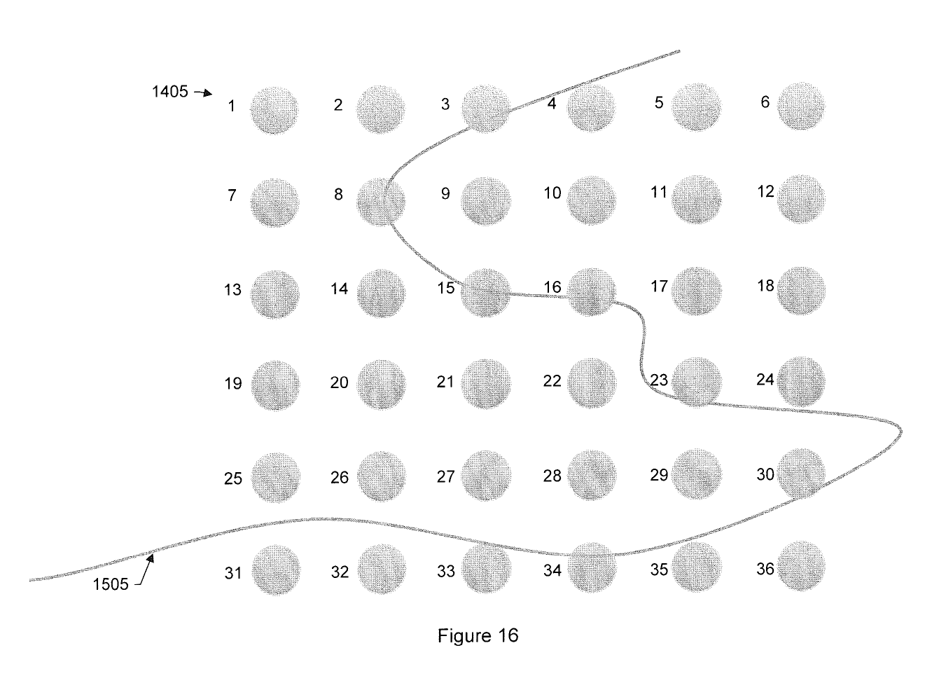

FIG. 14 shows a set of nodes 1405 that are placed at various locations on a floor plan of store. The set of nodes have been assigned node identifiers or indices (e.g., node indices 1-36). In this example, there are 36 nodes. It should be appreciated, however, that there can be any number of nodes depending on factors such as the area of the store, desired granularity, and application of the system. In a specific implementation, placement of the nodes is based on traffic density. In this specific implementation, denser traffic areas have more nodes than sparser traffic areas. FIG. 15 shows an example of a track 1505 that represents a customer's movement in a store. FIG. 16 shows track 1505 (FIG. 15) having been superimposed over set of nodes 1405 (FIG. 14).

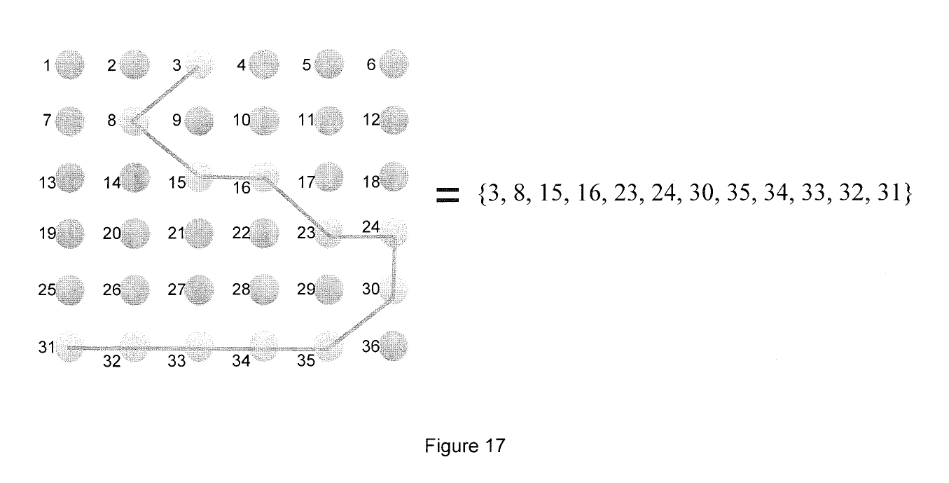

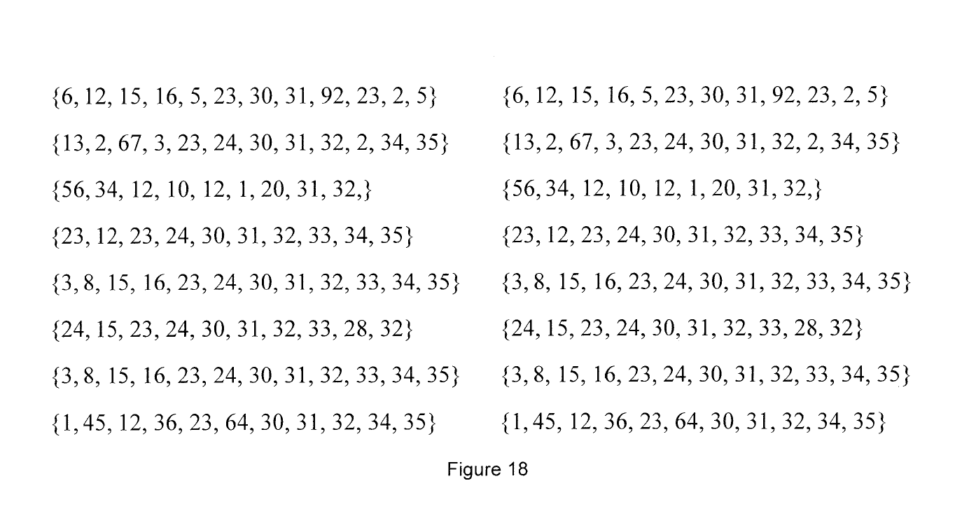

FIG. 17 shows track 1505 having been correlated to set of nodes 1405. In a specific implementation, each point of a given track and is correlated to a single node using a least-Euclidean-distance metric. The output of the track-to-node correlation is a node sequence having a set of node indices. In this example, track 1505 is converted to a node sequence having node indices {3, 8, 15, 16, 23, 24, 30, 35, 34, 33, 32, 31}. Track-to-node correlations are performed for each of the collected tracks in order to obtain a set of node sequences corresponding to the movements represented in the original tracks. FIG. 18 shows an example of node sequences. Each node sequence represents a path of a customer through the store.

In a specific implementation, the technique of converting tracks-to-nodes may be referred to as star graphs or star graphing. Star graphs include a set of nodes positioned according to available data, and sequences of motion through those nodes, derived from raw track data. The abstraction of track data to a set of node sequences allows for an understanding of movement patterns, directionality, and flow. Reducing potentially complex motion tracks to sequences of node indices, allows the application of various pattern recognition and statistical analysis techniques.

In other words, in this specific implementation, in order to capture temporality and sequencing of movement, a data structure referred to as a star graph is derived from the movement traces. A star graph includes a set of nodes placed according to the density of the data. Each distinct track is then correlated to a set of nodes, whereby each point on the track is considered to belong to a single node (often just the nearest node in space, but not necessarily). A track then becomes a sequence of nodes. These node sequences can then be quantified and analyzed more effectively than the “raw” movement traces.

Referring now to FIG. 13, in a step 1315 the set of node sequences are associated with a set of consumer behavior patterns. In a specific implementation, the association includes a form of clustering to group node sequences. These groups can then be manually labeled. An example might be, in a grocery store, a retailer expects to see one cluster for people doing their weekly shopping, another cluster for people shopping for a party, and a third cluster for people buying lunch during the workday.

In a specific implementation, the association may be performed by an administrator or other human operator. The system can provide a graphical user interface tool to facilitate the association. For example, the GUI tool may include first and second drop down controls. The first drop down control lists the node sequences. The second drop down control lists the consumer behaviors to be associated with the node sequences. Some examples of consumer behaviors include shoplifting, leaving store without making a purchase, and others.

In another specific implementation, associating consumer behavior patterns to the set of node sequences may be automatically performed by the system. In this specific implementation, the system can cross reference sales data for a customer with the customer's path through the store. For example, the sales data may include a size or dollar amount of the customer's purchase, a quantity of items purchased (e.g., customer purchased one can of soda versus customer purchased an entire case of soda), an identification of the items purchased, and others.

In a step 1320, the system tracks a target customer in the store and generates a target node sequence that represents a current path of the target customer in the store.

In a step 1325, the system compares the target node sequence with the set of node sequences to determine a consumer behavior pattern associated with the target node sequence. In a specific implementation, the comparison includes calculating a string edit or Levenshtein distance between the target node sequence and a node sequence of the set of node sequences. In this specific implementation, a string edit distance is computed over the set of node sequences in a target star graph as compared to a star graph representing the background or “normal” behavior.

In a specific implementation, the system takes the 10 most common sequences in each star graph to be compared, and treats each entry as a word. String edit distance is then the number of “moves” required to turn one sequence into the other. Two identical sequences will therefore have a string edit distance of 0. In this context, string edit distance can be thought of as analogous to KL-divergence as discussed previously. In an implementation, a method includes calculating an average and then comparing each sequence of interest (which can itself be an average or aggregate) to the original average. This provides a way to compare individual behavior to “normal.” In another specific implementation, an analysis includes an n-gram analysis. This analysis includes computing the probability of each specific sequence of length “n” given a dataset. The analysis can include analyzing how unusual a new sequence is by computing the probability for each subsequence.

A predetermined threshold value can be stored in order to determine when a first sequence resembles a second sequence. For example, in a specific implementation, a distance is calculated between the first and second sequence. The distance is compared to a threshold value. If the distance is less than the threshold value, a determination is made that the first sequence is the same as or resembles the second sequence. If the distance is greater than the threshold value, a determination is made that the first sequence is different from the second sequence. Having a threshold value can help account for insignificant differences in the sequences.

In a step 1330, based on the consumer behavior pattern associated with the target node sequence, the system makes a prediction about the target customer. In an n-gram analysis, given a sequence of length “n−1” the system can then compute the probability for each possible sequence of length “n” with the highest probability sequence being the prediction.

In a specific implementation, the prediction is made before the target customer leaves the store. For example, the prediction may be that the customer is likely to engage in shoplifting. If such a prediction is made, the system can generate a security alert (e.g., text message or other notification) that can be sent to a security guard to intercept the customer, or follow and monitor the customer.

As another example, the prediction may be that the customer is likely to leave the store without making a purchase. If such a prediction is made, the system can generate an alert or other notification to be sent to a salesperson. The salesperson can then approach the customer to offer assistance. The assistance may include, for example, finding a particular size for the customer, helping the customer coordinate an outfit, helping the customer choose accessories, informing the customer about what items are on sale, informing the customer about promotions, and the like.

In a specific implementation, a method includes calculating a first string edit distance between the target node sequence and a first node sequence associated with a first consumer behavior pattern, calculating a second string edit distance between the target node sequence and a second node sequence associated with a second consumer behavior pattern. The method further includes if the first string edit distance is less than the second string edit distance, associating the first consumer behavior pattern to the target customer, and if the second string edit distance is less than the first string edit distance, associating the second consumer behavior pattern to the target customer.

In another specific implementation, a method includes calculating a first distance between the target node sequence and a first node sequence of the set of node sequences, calculating a second distance between the target node sequence and a second node sequence of the set of node sequences. If the first distance is less than the second distance, identifying a consumer behavior pattern associated with the first node sequence as being associated with the target node sequence. If the second distance is less than the first distance, identifying a consumer behavior pattern associated with the second node sequence as being associated with the target node sequence.

In another specific implementation, a method includes calculating a first distance between the target node sequence and a first node sequence of the set of node sequences, calculating a second distance between the target node sequence and a second node sequence of the plurality of node sequences. If the first distance is closer to zero than the second distance, identifying a consumer behavior pattern associated with the first node sequence as being associated with the target node sequence. If the second distance is closer to zero than the first distance, identifying a consumer behavior pattern associated with the second node sequence as being associated with the target node sequence.

In another specific implementation, a method includes calculating a Levenshtein distance between the target node sequence and at least a subset of the set of node sequences to determine a consumer behavior pattern associated with the target node sequence, identifying a smallest Levenshtein distance as being between the target node sequence and a first node sequence of the at least a subset of the set of node sequences, and predicting a first consumer behavior pattern for the target customer, where the predicted first consumer behavior pattern is associated with the first node sequence.

In the description above and throughout, numerous specific details are set forth in order to provide a thorough understanding of an embodiment of this disclosure. It will be evident, however, to one of ordinary skill in the art, that an embodiment may be practiced without these specific details. In other instances, well-known structures and devices are shown in block diagram form to facilitate explanation. The description of the preferred embodiments is not intended to limit the scope of the claims appended hereto. Further, in the methods disclosed herein, various steps are disclosed illustrating some of the functions of an embodiment. These steps are merely examples, and are not meant to be limiting in any way. Other steps and functions may be contemplated without departing from this disclosure or the scope of an embodiment.

What is claimed is:

1. A method comprising:
collecting first tracking data representing movements of a first set of customers through a store during a first time period;
generating a first distribution using the first tracking data;
collecting second tracking data representing movements of a second set of customers through the store during a second time period, different from the first time period;
generating a second distribution using the second tracking data;
comparing one of the first or second distributions to another of the first or second distributions; and
based on the comparison, calculating a first value indicating a degree of difference between the one of the first or second distributions and the other of the first or second distributions.

2. The method of claim 1 wherein the generating a first distribution comprises:
establishing a set of locations on a floor plan of the store; and
analyzing the first tracking data against the set of locations to count a number of customers of the first set of customers passing by each location of the set of locations during the first time period.

3. The method of claim 2 wherein the generating a second distribution comprises:
analyzing the second tracking data against the set of locations to count a number of customers of the second set of customers passing by each location of the set of locations during the second time period.

4. The method of claim 1 wherein the first time period comprises a first day of a week, and the second time period comprises a second day of the week, different from the first day.

5. The method of claim 1 wherein the first tracking data comprises a plurality of tracks, each track being associated with a customer of the first set of customers and being defined by a plurality of points, each point indicating a position of the customer in the store at a time during the first time period, wherein the generating a first distribution comprises:
dividing a floor plan of the store into a plurality of locations, each location being associated with a counter variable;
determining whether a first point of a first track associated with a first customer is within a first location of the plurality of locations; and
if the first point is within the first location, thereby indicating that the first customer visited the first location, incrementing a first counter variable associated with the first location.

6. The method of claim 1 wherein the first distribution comprises a first spatial histogram and the second distribution comprise a second spatial histogram.

7. The method of claim 1 wherein the first value comprises a Kullback-Leibler (KL) divergence.

8. The method of claim 1 comprising:
calculating for at least one of the first or second distributions a second value indicating an amount of randomness in the at least one of the first or second distributions.

9. The method of claim 1 comprising:
calculating for at least one of the first or second distributions a second value indicating a degree of clustering in the at least one of the first or second distributions.

10. The method of claim 1 wherein the first distribution is associated with a first physical layout of the store during the first time period, and the second distribution is associated with a second physical layout of the store, different from the first physical layout, during the second time period.

11. The method of claim 1 comprising:
correlating the first distribution to a first value of a sales conversion metric calculated for the first time period; and
correlating the second distribution to a second value of the sales conversion metric calculated for the second time period.

12. A method comprising:
collecting first tracking data representing movements of a first set of customers through a first layout of a store;
generating a first distribution using the first tracking data;
correlating the first distribution to a first value of a sales metric;
collecting second tracking data representing movements of a second set of customers through a second layout of the store, different from the first layout;
generating a second distribution using the second tracking data;
correlating the second distribution to a second value of the sales metric; and
comparing the first value of the sales metric to the second value of the sales metric to determine whether to recommend the first layout or the second layout.

13. The method of claim 12 wherein the sales metric comprises sales conversion.

14. The method of claim 12 wherein the generating a first distribution comprises:
counting a number of customers of the first set of customers who pass by a specific location in the store.

15. The method of claim 12 comprising:
counting a number of customers of the first set of customers who pass by a specific location in the store to generate the first distribution; and
counting a number of customers of the second set of customers who pass by the specific location in the store to generate the second distribution.

16. The method of claim 12 wherein a number of displays in the first layout is different from a number of displays in the second layout.

17. The method of claim 12 wherein a location of a display in the first layout is different from a location of the display in the second layout.

18. A method comprising:
collecting a plurality of tracking data;
generating a plurality of distributions using the plurality of tracking data;
correlating the plurality of distributions to a plurality of values of a sales metric;
receiving a target distribution associated with a target layout;
comparing the received target distribution with the plurality of distributions to identify a distribution that resembles the target distribution;
based on the comparison, determining that a first distribution of the set of distributions resembles the target distribution; and
predicting a first value of the sales metric for the target layout, wherein the first value of the sales metric is correlated to the first distribution.

19. The method of claim 18 wherein the comparing the received target distribution with the plurality of distributions comprises:
calculating a Kullback-Leibler (KL) divergence between a distribution of the plurality of distributions and the target distribution.

20. The method of claim 18 wherein the plurality of distributions comprise spatial histograms.

21. The method of claim 18 wherein the sales metric comprises sales conversion.
